(19) United States
(12) Patent Application Publication
(10) Pub. No.: US 2026/0312828 A1
(43) Pub. Date: Oct. 8, 2026

(54) Methods and Systems for Processing Data

(71) Applicant: Siemens Aktiengesellschaft, München (DE)

(72) Inventors: Rainer Falk, München (DE); Hans Aschauer, München (DE); Stefan Becker, Erlangen (DE); Christian Peter Feist, München (DE); Frank Laurig, Erlangen (DE); Anna Palmin, Karlsruhe (DE)

(73) Assignee: Siemens Aktiengesellschaft, München (DE)

(21) Appl. No.: 19/483,195

(22) PCT Filed: Apr. 24, 2024
(86) PCT No.: PCT/EP2024/061149

§ 371 Date: Nov. 10, 2025

(30) Foreign Application Priority Data
May 11, 2023 (EP) 23172767.8

(51) Int. Cl. H04L 9/32; G06F 21/44; G06F 21/62; H04L 9/08; H04L 9/30

(52) U.S. Cl. CPC H04L 9/3268; G06F 21/44; G06F 21/6209; H04L 9/0825; H04L 9/30; H04L 9/3247

(57) ABSTRACT

Various embodiments include a method for processing data in a communication system including a device, a registration authority, and a certificate authority. An example includes: requesting a digital certificate for the device using a certificate signature request; supplying device attributes based on the request; performing a check on the certificate signature request relating to the device using the registration authority; encoding the specific device attributes into the requested digital certificate to obtain a digital device certificate comprising the specific device attributes by way of the registration authority; if the check is successful, signing the digital device certificate using the private key of the certificate authority to issue a signed digital device certificate by way of the certificate authority; supplying the issued signed digital device certificate to the device; and performing an access scheme to access a resource using the device and the issued signed digital device certificate.

### CROSS-REFERENCE TO RELATED APPLICATIONS

This application is a U.S. National Stage Application of International Application No. PCT/EP 2024/061149 filed Apr. 24, 2024, which designates the United States of America, and claims priority to EP Application No. 23172767.8 filed May 11, 2023, the contents of which are hereby incorporated by reference in their entirety.

### TECHNICAL FIELD

The present disclosure relates to communications. Various embodiments include methods, computer program products, and communication systems for processing data.

### BACKGROUND

“Zero trust” access control usually involves not only the accessing user being authenticated, but also other criteria being checked and used for an access control decision. By way of example, access can involve checking whether the device is a company-administered device or whether the device has an up-to-date patch status. However, this means that this information is repeatedly determined and checked for access operations or for authentication to an identity and access management server (IAM server). This results in repeated checks and also in relatively frequent determination and transmission of information that is needed for an access control decision.

Normally, a user authenticates themselves to an IAM access control system by means of a password, an authentication token or a digital certificate. The NIST SP800-207 “Zero Trust Architecture” [1] generally describes the zero trust concept, for which section 2.1 describes the use of dynamic access control policies: “4. Access to resources is determined by dynamic policy including the observable state of client identity, application/service, and the requesting asset and may include other behavioral and environmental attributes.”

Furthermore, the prior art reveals that not only the identification information but also permissions information may be encoded in an authentication certificate based on the X.509 standard. This is accomplished by encoding information about the granted role and about the extent to which the role can be performed into the authentication certificate (see also [2], section III. F). Moreover, attribute certificates are known, which can also be referred to as authorization certificates [3].

### SUMMARY

Some embodiments of the teachings herein include a computer-implemented method for processing data in a communication system (100) that comprises a device (10), a registration authority (RA) and a certificate authority (CA), comprising: a) requesting (S10) a digital certificate for the device (10) by means of a certificate signature request (CSR), b) supplying (S20), on the basis of the request, device attributes specific to the device, c) performing (S30), by way of the registration authority (RA), a check on the certificate signature request (CSR) relating to the device (10), d) encoding (S40), by way of the registration authority (RA), the specific device attributes into the requested digital certificate to obtain a digital device certificate comprising the specific device attributes, e) performing (S50), if the check is successful, by way of the certificate authority (CA), signing of the digital device certificate, using the private key of the certificate authority (CA), to issue a signed digital device certificate (ZT-Cert), f) supplying (S60) the issued signed digital device certificate (ZT-Cert) to the device (10), and g) performing (S70) an access scheme to access a resource (30) by way of the device (10) on the basis of the issued signed digital device certificate (ZT-Cert).

In some embodiments, supply according to step b) (S20) also comprises performing a device scan by means of a scanning unit (40) to determine the specific device attributes.

In some embodiments, performance of the device scan comprises a network scan of the device, an interrogation regarding the specific device attributes using an Open Platform Communications Unified Architecture or a Simple Network Management Protocol and/or an interrogation of a device management system in which the specific device attributes for the device (10) are stored.

In some embodiments, supply according to step b) (S20) comprises transferring, on the basis of the request and together with the certificate signature request (CSR), the specific device attributes to at least the registration authority (RA).

In some embodiments, the specific device attributes comprise first zero trust attributes, performance according to step e) (S50) also comprising checking, by way of the registration authority (RA), the admissibility of an ascertained value of one of the first zero trust attributes.

In some embodiments, the specific device attributes comprise first information indicating whether a device configuration compliance check has taken place during the issuing of the signed digital device certificate according to step e) (S50), second information indicating what specific device attributes have been checked during the issuing of the signed digital device certificate according to step e) (S50), and/or third information providing information about determined attribute values of the specific device attributes.

In some embodiments, the issued signed digital device certificate (ZT-Cert) has an ascertained validity period, e.g. of one day, several days or one week.

In some embodiments, the issued signed digital device certificate (ZT-Cert) comprises a certificate extension, the certificate extension comprising, in a first extension field, a reference to at least one attribute certificate in which additional device attributes specific to the device (10) are securely stored.

In some embodiments, the issued signed digital device certificate (ZT-Cert) comprises a further certificate extension, the further certificate extension comprising, in a second extension field, a root of trust for at least one further attribute certificate, the root of trust comprising the public key of the certificate authority (ZA).

In some embodiments, the communication system (100) also comprises an access control apparatus (20) having a security rule decision point (PDP) and a security rule enforcement point (PEP), performance of the access scheme according to step g) (S70) also comprising: g1) requesting (S71), by way of the device (10), a permission to access the resource (30) by way of the device (10), g2) checking (S72) the permission by way of the security rule decision point (PDP) by applying predefined access rules (AP) to the specific device attributes of the issued signed digital device certificate (ZT-Cert) to obtain a first access result, g3) if the first access result is positive, allowing (S73) the device (10) to access the resource (30) by way of the security rule enforcement point (PEP), or if the first access result is negative, preventing (S74) the device (10) from accessing the resource (30) by way of the security rule enforcement point (PEP).

In some embodiments, after the checking according to step g2) (S72), the method also comprises: h) rechecking (S80), during security-critical access by way of the device (10) to the resource (30) or during authentication of the device (10) in the access control apparatus (20), the permission to access the resource (30) by way of the device (10) by way of the security rule decision point (PDP) by applying the predefined access rules (AP) to the specific device attributes of the issued signed digital device certificate to obtain a second access result, i) resupplying (S90), during security-critical access by way of the device (10) to the resource (30) or during authentication of the device (10) in the access control apparatus (20), the supplied specific device attributes, and/or j) rechecking (S100), during the security-critical access by way of the device (10) to the resource (30) or during the authentication of the device (10) in the access control apparatus (20), the permission to access the resource (30) by way of the device (10) by way of the security rule decision point (PDP) by applying the predefined access rules (AP) to the resupplied specific device attributes of the issued signed digital device certificate to obtain a third access result.

In some embodiments, step g1) (S71) also comprises supplying, on the basis of the request or further authentication of the device (10) in the access control apparatus (20), the specific device attributes comprising second zero trust attributes having respective further ascertained values.

In some embodiments, the resource (30) is in the form of a service, in particular in the form of an IoT service, in the form of a provisioning server or in the form of an onboarding server.

As another example, some embodiments include a computer program product, comprising instructions that, when the program is executed by a computer, cause said computer to carry out one or more of the methods described herein.

As another example, some embodiments include a communication system (100) for processing data, comprising a device (10), a first supply unit (50), a second supply unit (60), a performance unit (70), a registration authority (RA) and a certificate authority (CA), the device (10) being designed to request a digital certificate for the device (10) by means of a certificate signature request (CSR), the first supply unit (50) being designed to supply, on the basis of the request, device attributes specific to the device, the registration authority (RA) being designed to perform a check on the certificate signature request (CSR) relating to the device (10), the registration authority (RA) being designed to encode the specific device attributes into the requested digital certificate to obtain a digital device certificate comprising the specific device attributes, the certificate authority (ZA) being designed to perform, if the check is successful, signing of the digital device certificate, using the private key of the certificate authority (CA), to issue a signed digital device certificate (ZT-Cert), the second supply unit (60) being designed to supply the issued signed digital device certificate (ZT-Cert) to the device (10), and the performance unit (70) being designed to perform an access scheme to access a resource (30) by way of the device (10) on the basis of the issued signed digital device certificate (ZT-Cert).

### BRIEF DESCRIPTION OF THE DRAWINGS

The teachings of the present disclosure are explained in more detail below on the basis of example embodiments with reference to the accompanying figures. Irrespective of the grammatical gender of a particular term, persons of masculine, feminine or other gender identity are also included. In the drawings:

FIG. 1 shows a schematic block diagram of an example communication system for processing data incorporating teachings of the present disclosure; and

FIG. 2 shows a schematic flowchart for an example method for processing data incorporating teachings of the present disclosure.

Identical or functionally identical elements in the figures have been provided with the same reference signs unless indicated otherwise.

### DETAILED DESCRIPTION

Against this background, teachings of the present disclosure may be used to improve access to a resource. In some example, a method for processing data in a communication system that comprises a device, a registration authority and a certificate authority may comprise:
a) requesting a digital certificate for the device by means of a certificate signature request,
b) supplying, on the basis of the request, device attributes specific to the device,
c) performing, by way of the registration authority, a check on the certificate signature request relating to the device,
d) encoding, by way of the registration authority, the specific device attributes into the requested digital certificate to obtain a digital device certificate comprising the specific device attributes,
e) performing, if the check is successful, by way of the certificate authority, signing of the digital device certificate, using the private key of the certificate authority, to issue a signed digital device certificate,
f) supplying the issued signed digital device certificate to the device, and
g) performing an access scheme to access a resource by way of the device on the basis of the issued signed digital device certificate.

Using the computer-implemented method according to the first aspect improves access control for a resource by encoding specific device attributes into a digital certificate.

The such a method allows the issuing of the digital certificate for the device to involve specific device attributes being encoded into the digital certificate, thereby obtaining a digital device certificate. The obtained digital device certificate is then signed in order to issue a signed digital device certificate. As a result, the issued signed digital device certificate contains information (the specific device attributes) regarding what specific device attributes (zero trust attributes) have already been determined during the issuing of the signed digital device certificate.

When the device accesses or is authenticated for the resource, merely the signed digital device certificate used results in additional information being available that is needed for a zero trust access control decision. Therefore, the specific device attributes do not need to be re-determined for authentication or when accessing the resource. The signed digital device certificate used thus provides a communication partner with information regarding what zero trust attributes have already been determined during the issuing of the signed digital device certificate and what zero trust attribute values have already had their content checked.

This may provide the advantage that the access control decision no longer requires the specific device attributes to be determined, which in turn reduces the computational complexity whenever the resource is accessed and thus saves computing resources. Consequently, the specific device attributes used for access checking are determined more efficiently.

The method further allows simple zero trust migration for legacy communication protocols that, although supporting certificate-based authentication, do not support an independent zero trust check beyond that. As a result, particularly in industrial environments with established OT (Operational Technology) communication protocols protected by means of IPsec (Internet Protocol security) or TLS/DTLS (Transport Layer Security/Datagram Transport Layer Security), a zero-trust functionality can be upgraded without modifying the communication protocol itself.

In addition, in an offline communication scenario, e.g. during local remote service access to a control unit (to the resource) similar to in the standard IEC62351-8, the control unit can be provided with zero trust information relating to the accessing party, or to the device used for access, by means of the signed digital device certificate used.

In some embodiments, the device is, by way of example, an IoT (Internet of Things) device, in particular an industrial IoT device, a control unit, a programmable logic controller, a machine tool, a production machine, a robot, a 3D printer for additive manufacturing, a remote input/output module (remote IO module) for locally connecting sensors and actuators, an IoT gateway or a network device of an industrial communication network.

The registration authority is an instance within a public key infrastructure and serves as a registration agency for digital certificates.

In information security, the certificate authority is an organization that issues digital certificates. A digital certificate is used to assign a particular public key to a person or organization. This association is verified by the certificate authority by providing it with its own digital signature.

In some embodiments, the digital certificate is an authentication certificate, e.g. an X.509 standard certificate. The issued signed digital device certificate contains at least information about the zero-trust status of the device per se.

In some embodiments, the request, e.g. by way of the device, according to step a) can be made at a particular time independently of performance of the access scheme.

The certificate signature request is a digital application to produce, for a public key and the identity information of the applicant, a digital identity certificate (also referred to as a public key certificate) protected by means of a digital signature. In particular, the certificate signature request comprises the identity of the applicant, in particular the device, and the public key of the applicant.

In some embodiments, the registration authority checks the identity and the public key of the device during the check on the certificate signature request. In some embodiments, signing comprises applying the private key of the certificate authority to a hash value of the digital device certificate, which is formed by means of a hash function. The issued signed digital device certificate can also be called a zero-trust certificate.

In some embodiments, supply according to step b) also comprises performing a device scan by means of a scanning unit to determine the specific device attributes. The device scan can also be called an “active attribute discovery”.

In some embodiments, performance of the device scan comprises a network scan of the device, an interrogation regarding the specific device attributes using an Open Platform Communications Unified Architecture or a Simple Network Management Protocol and/or an interrogation of a device management system in which the specific device attributes for the device are stored.

In some embodiments, supply according to step b) comprises transferring, on the basis of the request and together with the certificate signature request, the specific device attributes to at least the registration authority. These embodiments do not involve a device scan being performed. It involves the specific device attributes being transferred together with the certificate signature request. The specific device attributes can be transferred, together with the certificate signature request, in the form of an attestation cryptographically protected by means of an attestation key. The certificate signature request can be transferred in a manner protected by means of a certificate request key, which is in a different form than the attestation key.

In some embodiments, the specific device attributes comprise first zero trust attributes, performance according to step e) also comprising checking, by way of the registration authority, the admissibility of an ascertained value of one of the first zero trust attributes. In particular, in step e), that is to say during the actual issuing, the first zero trust attributes included in the specific device attributes are used to check, by way of the registration authority, whether the ascertained value of a first zero trust attribute is admissible. A specific device attribute can also be called a zero-trust attribute, in particular a first zero trust attribute. The registration authority can perform the check independently or, to check the admissibility of the first zero trust attribute, can interrogate another system, in particular a device management system or a device directory system.

In some embodiments, the specific device attributes comprise first information indicating whether a device configuration compliance check has taken place during the issuing of the signed digital device certificate according to step e), second information indicating what specific device attributes have been checked during the issuing of the signed digital device certificate according to step e), and/or third information providing information about determined attribute values of the specific device attributes. Whether a device configuration compliance check has taken place during the issuing of the signed digital device certificate according to step e) means in particular whether the device meets the defined company compliance specifications, that is to say for example whether it is enterprise managed, whether the patch status is up to date and/or whether the virus scanner is active and equipped with the up-to-date virus pattern.

The second information indicates in particular what specific device attributes have been checked during the issuing of the signed digital device certificate according to step e), that is to say for example whether the specific device attribute “enterprise managed”, the specific device attribute “patch status up to date” and/or the specific device attribute “virus scanner active” has been checked.

In some embodiments, the third information indicates the status of a flag that reveals whether the device is enterprise managed and optionally what device management domain it is in. The third information can also indicate particular values pertaining to specific device attributes, for example the value or the version of the determined patch status and/or the determined version of the virus patterns.

In some embodiments, the issued signed digital device certificate has an ascertained validity period, e.g. of one day, several days or one week. The particular validity period is in particular chosen to be so short because a zero trust attribute or zero trust information can change, and the validity of the zero trust attribute is thus may be regularly renewed.

In some embodiments, the issued signed digital device certificate comprises a certificate extension, the certificate extension comprising, in a first extension field, a reference to at least one attribute certificate in which additional device attributes specific to the device are securely stored. A certificate extension is in particular an information field that can provide additional information pertaining to certificates. A certificate extension provides a way of extending the original X.509 standards for certificate information.

In some embodiments, the issued signed digital device certificate comprises a further certificate extension, the further certificate extension comprising, in a second extension field, a root of trust for at least one further attribute certificate, the root of trust comprising the public key of the certificate authority. The root of trust in the further certificate extension can be used to produce the validity of the confirmation of the zero trust attribute(s) within the specific device attributes directly.

In some embodiments, that the validity period of the attribute certificate, for example one day, can be significantly shorter than that of an authentication certificate, which has a relatively long validity period, for example 1 or 2 years. The attribute certificate can be issued by a different authority than the authentication certificate (digital certificate), thereby simplifying organizational division of responsibilities.

The reference that the issued signed digital device certificate includes in the further certificate extension relates in particular not to an actual certificate, for example to the serial number and the issuer, but rather to a symbolic name that describes the attributes included in the attribute certificate.

In some embodiments, the issued signed digital device certificate, for example an authentication certificate, refers to one or more attribute certificates. Conversely, in the prior art, only the attribute certificate refers to the authentication certificate, or the “owner” of the certificate mentioned in the common name (CN) of the certificate.

The public key and the private key are cryptographic keys used within a public key infrastructure. A root of trust is in particular called a trust anchor and is issued by a root certificate authority (root CA). The root certificate instance can be used to traceably check the entire certificate chain from the root certificate instance to the individual digital certificates issued within a PKI.

In some embodiments, the communication system also comprises an access control apparatus, the access control apparatus having a security rule decision point and a security rule enforcement point, performance of the access scheme according to step g) also comprises:
g1) requesting, by way of the device, a permission to access the resource by way of the device,
g2) checking the permission by way of the security rule decision point by applying predefined access rules to the specific device attributes of the issued signed digital device certificate to obtain a first access result,
g3) if the first access result is positive, allowing the device to access the resource by way of the security rule enforcement point, or
if the first access result is negative, preventing the device from accessing the resource by way of the security rule enforcement point.

In some embodiments, an access control apparatus is an apparatus that stipulates which device and when a device can or cannot access a resource. The security rule decision point is in particular a PDP (Policy Decision Point). The PDP is an instance in which policy decisions are made. The security rule enforcement point is in particular a PEP (Policy Enforcement Point). The PEP is an instance that has the implementation to enforce the policy decisions made by the PDP.

The predefined access rules are rules on the basis of which access to the resource is decided.

In some embodiments, after the checking according to step g2), the method also comprises:
h) rechecking, during security-critical access by way of the device to the resource or during authentication of the device in the access control apparatus, the permission to access the resource by way of the device by way of the security rule decision point by applying the predefined access rules to the specific device attributes of the issued signed digital device certificate to obtain a second access result,
i) resupplying, during security-critical access by way of the device to the resource or during authentication of the device in the access control apparatus, the supplied specific device attributes, and/or
j) rechecking, during the security-critical access by way of the device to the resource or during the authentication of the device in the access control apparatus, the permission to access the resource by way of the device by way of the security rule decision point by applying the predefined access rules to the resupplied specific device attributes of the issued signed digital device certificate to obtain a third access result.
This allows two-stage determination of zero trust attribute values in the specific device attributes. Some zero trust attribute values in the specific device attributes, for example the first zero trust attributes, are determined during the actual issuing of the signed digital device certificate according to step e) and stored in the signed digital device certificate (first stage of determination).

Other zero trust attribute values, for example second zero trust attributes, are determined in the access control apparatus only during authentication of the device or access by the device (second stage of determination). This furthermore allows two-stage determination of zero trust attribute values in the specific device attributes:

In particular, steps h), i) and/or j) can also be performed at a random time, for example at random.

In some embodiments, step g1) also comprises supplying, on the basis of the request or further authentication of the device in the access control apparatus, the specific device attributes comprising second zero trust attributes having respective further ascertained values. This involves for example the second zero trust attributes being determined only during authentication of the device or access by the device in the access control apparatus (which corresponds to the above second stage of determination). A specific device attribute can also be called a zero trust attribute, in particular a second zero trust attribute.

In some embodiments, the resource is in the form of a service, in particular in the form of an IoT service, in the form of a provisioning server or in the form of an onboarding server.

In some embodiments, a computer program product comprises instructions that, when the program is executed by a computer, cause said computer to carry out one or more of the methods described herein. A computer program product, e.g. a computer program means, can be supplied or delivered for example as a storage medium, e.g. a memory card, USB stick, CD-ROM, DVD, or in the form of a downloadable file from a server in a network. This can take place for example in a wireless communication network by way of the transmission of an appropriate file containing the computer program product or the computer program means.

In some embodiments, a communication system for processing data, comprises a device, a first supply unit, a second supply unit, a performance unit, a registration authority and a certificate authority,
the device being designed to request a digital certificate for the device by means of a certificate signature request,
the first supply unit being designed to supply, on the basis of the request, device attributes specific to the device,
the registration authority being designed to perform a check on the certificate signature request relating to the device,
the registration authority being designed to encode the specific device attributes into the requested digital certificate to obtain a digital device certificate comprising the specific device attributes,
the certificate authority being designed to perform, if the check is successful, signing of the digital device certificate, using the private key of the certificate authority, to issue a signed digital device certificate,
the second supply unit being designed to supply the issued signed digital device certificate to the device,
the performance unit being designed to perform an access scheme to access a resource by way of the device on the basis of the issued signed digital device certificate.

In some embodiments, the communication system is in the form of an automation system. The automation system can be an automation installation from the process industry, the chemical industry, the pharmaceutical industry, the petrochemical industry or an installation from the food and beverage industry. These also include all installations from the manufacturing and production industry and installations in which e.g. automobiles or goods of all kinds are produced. The automation system can furthermore be an energy automation system, a power transmission system, a power station, an electrolyzer, a building automation system or a railroad automation system.

The respective unit, for example the scanning unit and/or the first supply unit, may be implemented using hardware and/or also using software. In the case of a hardware implementation, the respective unit can be in the form of an apparatus or in the form of part of an apparatus, for example in the form of a computer or in the form of a microprocessor or in the form of a control computer of a vehicle. In the case of a software implementation, the respective unit can be in the form of a computer program product, in the form of a function, in the form of a routine, in the form of part of a program code or in the form of an executable object.

Any technical effects and advantages described in relation to the method apply in equal measure to the communication systems. Furthermore, embodiments and features described with reference to the methods apply accordingly to the communication system. Other possible implementations of the teachings herein include combinations, which are also not explicitly cited, of features or embodiments described above or below for the exemplary embodiments. In these cases, a person skilled in the art will also add individual aspects to the respective basic forms as improvements or additions. Other advantageous refinements and aspects of the teachings herein are the subject matter of the subclaims and of the exemplary embodiments described below.

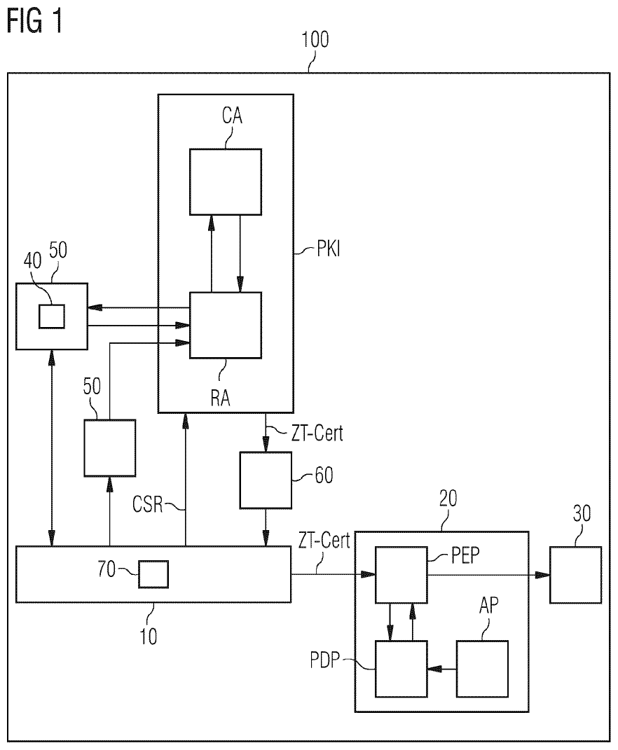

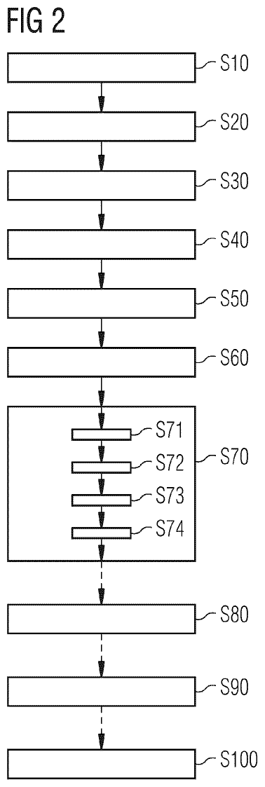

FIG. 1 shows a schematic block diagram of an example communication system 100 for processing data incorporating teachings of the present disclosure, comprising a device 10, a first supply unit 50 (produced in two embodiments, see FIG. 1), a second supply unit 60, a performance unit 70, a registration authority RA, a certificate authority CA and a scanning unit 40. The registration authority RA and the certificate authority CA in FIG. 1 are arranged in a public key infrastructure PKI. In addition, the method steps of FIG. 2, which describe a method for processing data in a communication system 100, are indicated between parentheses in the explanations that follow for FIG. 1.

FIG. 1 shows an exemplary implementation in which a signed digital device certificate ZT-Cert is initially issued for the device 10. The device 10 then wishes to use the issued signed digital device certificate ZT-Cert to access a resource 30. The resource 30 in FIG. 1 is in the form of a service, in particular in the form of an IoT service. In some embodiments, the resource 30 can also be in the form of a provisioning server or in the form of an onboarding server.

The device 10 in FIG. 1 is initially designed to request a digital certificate for the device 10 by means of a certificate signature request CSR (see step S10 in FIG. 2).

The first supply unit 50 is then designed to supply, on the basis of the request, device attributes specific to the device (see step S20 in FIG. 2).

For this supply, the scanning unit 40 is designed to perform a device scan to determine the specific device attributes. Performance of the device scan comprises a network scan of the device, an interrogation regarding the specific device attributes using an Open Platform Communications Unified Architecture or a Simple Network Management Protocol and/or an interrogation of a device management system in which the specific device attributes for the device 10 are stored (see FIG. 1, the arrangement of the scanning unit 40 inside the first supply unit 50).

In some embodiments, supply can also take place without the scanning unit 40. In this case, when supplying the specific device attributes, the first supply unit 50 is designed to transfer the specific device attributes to at least the registration authority RA on the basis of the request and together with the certificate signature request CSR (see FIG. 1, the arrows from the device 10 via the first supply unit 50 to the registration authority RA).

The specific device attributes comprise first information indicating whether a device configuration compliance check has taken place during the issuing of the signed digital device certificate according to step S50 (see FIG. 2), second information indicating what specific device attributes have been checked during the issuing of the signed digital device certificate according to step S50, and/or third information providing information about determined attribute values of the specific device attributes.

The registration authority RA in FIG. 1 is now designed to perform a check on the certificate signature request CSR relating to the device 10 (see step S30 in FIG. 2).

After that, the registration authority RA is designed to encode the specific device attributes into the requested digital certificate to obtain a digital device certificate comprising the specific device attributes (see step S40 in FIG. 2).

The certificate authority ZA is then designed to perform, if the check is successful and if, furthermore, the specific device attributes are encoded in the digital device certificate to be signed, signing of the digital device certificate, using the private key of the certificate authority CA, to issue a signed digital device certificate ZT-Cert (see step S50 in FIG. 2).

Furthermore, the specific device attributes comprise first zero trust attributes (not shown). For performance according to step S50, the registration authority RA is designed to check the admissibility of an ascertained value of one of the first zero trust attributes.

The second supply unit 60 is then designed to supply the issued signed digital device certificate ZT-Cert to the device 10 (see step S60 in FIG. 2). The issued signed digital device certificate ZT-Cert in FIG. 1 has an ascertained validity period of one day. In embodiments, the particular validity period is several days or one week.

The issued signed digital device certificate ZT-Cert in FIG. 1 comprises a certificate extension. The certificate extension comprises, in a first extension field, a reference to at least one attribute certificate in which additional device attributes specific to the device 10 are securely stored. In embodiments, the issued signed digital device certificate ZT-Cert comprises a further certificate extension. This further certificate extension comprises, in a second extension field, a root of trust for at least one further attribute certificate, the root of trust comprising the public key of the certificate authority ZA (not shown).

Subsequently, the performance unit 70 is designed to perform an access scheme to access a resource 30 by way of the device 10 on the basis of the issued signed digital device certificate ZT-Cert (see step S70 in FIG. 2).

To check the permission for the device 10 to access the resource 30 by performing the access scheme, the communication system 100 in FIG. 1 also comprises an access control apparatus 20 comprising a security rule decision point PDP and a security rule enforcement point PEP.

Performance of the access scheme on the basis of the performance unit 70 (see FIG. 2, step S70) also comprises the following steps:

The device 10 is initially designed to request permission for the device 10 to access the resource 30 (see step S71 in FIG. 2). Furthermore, the specific device attributes comprising second zero trust attributes having respective further ascertained values can also be supplied on the basis of the request or further authentication of the device 10 in the access control apparatus 20 (see also step S71 in FIG. 2).

The security rule decision point PDP is then designed to check the permission by applying predefined access rules AP to the specific device attributes of the issued signed digital device certificate ZT-Cert to obtain a first access result (see step S72 in FIG. 2). In other words, the security rule decision point PDP checks the specific device attributes. In embodiments, the security rule decision point PDP is designed to determine further specific device attributes (zero trust attributes) required for the access permission.

If the first access result is positive, the security rule enforcement point PEP is designed to allow the device 10 to access the resource 30 (see step S73 in FIG. 2). If the first access result is negative, the security rule enforcement point PEP is designed to prevent the device 10 from accessing the resource 30 (see step S74 in FIG. 2).

Furthermore, the security rule decision point PDP may be designed for other actions after the checking according to step S72.

By way of example, the security rule decision point PDP is then designed to recheck, during security-critical access by way of the device 10 to the resource 30 or during authentication of the device 10 in the access control apparatus 20, the permission to access the resource 30 by way of the device 10 by applying the predefined access rules AP to the specific device attributes of the issued signed digital device certificate to obtain a second access result (see step S80 in FIG. 2).

The first supply unit 50 is then designed to resupply, during security-critical access by way of the device 10 to the resource 30 or during authentication of the device 10 in the access control apparatus 20, the supplied specific device attributes (see step S90 in FIG. 2).

Furthermore, the security rule decision point PDP is then designed to recheck, during the security-critical access by way of the device 10 to the resource 30 or during the authentication of the device 10 in the access control apparatus 20, the permission to access the resource 30 by way of the device 10 by way of the security rule decision point PDP by applying the predefined access rules AP to the resupplied specific device attributes of the issued signed digital device certificate to obtain a third access result (see step S100 in FIG. 2).

FIG. 2 shows a schematic flowchart for an example method incorporating teachings of the present disclosure for processing data in a communication system 100 according to FIG. 1, which comprises a device 10, a registration authority RA and a certificate authority CA (see FIG. 1).

The respective method steps S10-S70 of the method have already been explained above with reference to FIG. 1, and so, to avoid repetition, method steps S10-S70 are not explained again. This also applies to method steps S80-S100, which are embodiments of method steps S10-S70 of the method and are therefore connected to method steps S10-S70 in FIG. 2 by means of appropriate dashed lines that have an arrow at one end. Method steps S71-S74 in FIG. 2, which are embodiments of method step S70, are also not described again, as method steps S71-S74 have already been explained in FIG. 1.

Although the present disclosure has been described on the basis of exemplary embodiments, it can be modified in a wide variety of ways.

### LIST OF REFERENCES

[1] https://nvlpubs.nist.gov/nistpubs/Special Publications/NIST.SP.800-207.pdf
[2] Rainer Falk, Steffen Fries, Chai Bisale: “Role-based Access Control in the Digital Grid—A Review of Requirements and Discussion of Solution Approaches”, International Journal on Advances in Security, vol. 10 No 3 & 4, year 2017, https://www.thinkmind.org/articles/sec_v10_n34_2017_8.pdf
[3] https://en.wikipedi.org/wiki/Authorization_certificate

What is claimed is:

1. A method for processing data in a communication system including a device, a registration authority, and a certificate authority, the method comprising:
a) requesting a digital certificate for the device using a certificate signature request;
b) supplying device attributes specific to the device based on the request;
c) performing a check on the certificate signature request relating to the device using the registration authority;
d) encoding the specific device attributes into the requested digital certificate to obtain a digital device certificate comprising the specific device attributes by way of the registration authority;
e) if the check is successful, signing the digital device certificate using the private key of the certificate authority to issue a signed digital device certificate by way of the certificate authority;
f) supplying the issued signed digital device certificate to the device; and
g) performing an access scheme to access a resource using the device on the basis of the issued signed digital device certificate.

2. The method as claimed in claim 1, wherein supply according to step b) comprises
performing a device scan using a scanning unit to determine the specific device attributes.

3. The method as claimed in claim 2, wherein performance of the device scan comprises performing a network scan of the device, an interrogation regarding the specific device attributes using an Open Platform Communications Unified Architecture or a Simple Network Management Protocol and/or an interrogation of a device management system in which the specific device attributes for the device are stored.

4. The method as claimed in claim 1, wherein supply according to step b) comprises
transferring the specific device attributes to the registration authority based on the request and together with the certificate signature request.

5. The method as claimed in claim 1, wherein:
the specific device attributes comprise first zero trust attributes; and
performance according to step e) includes
checking the admissibility of an ascertained value of one of the first zero trust attributes by way of the registration authority.

6. The method as claimed in claim 1, wherein the specific device attributes comprise first information indicating whether a device configuration compliance check has taken place during the issuing of the signed digital device certificate according to step e), second information indicating what specific device attributes have been checked during the issuing of the signed digital device certificate according to step e), and/or third information providing information about determined attribute values of the specific device attributes.

7. The method as claimed in claim 1, wherein the issued signed digital device certificate has an associated validity period.

8. The method as claimed in claim 1, wherein the issued signed digital device certificate comprises a certificate extension comprising, in a first extension field, a reference to an attribute certificate in which additional device attributes specific to the device are securely stored.

9. The method as claimed in claim 1, wherein the issued signed digital device certificate comprises a further certificate extension comprising, in a second extension field, a root of trust for at least one further attribute certificate, the root of trust comprising the public key of the certificate authority.

10. The method as claimed in claim 1, wherein the communication system comprises an access control apparatus having a security rule decision point and a security rule enforcement point; and
performance of the access scheme according to step g) also comprises:
g1) requesting a permission to access the resource from the device;
g2) checking the permission using the security rule decision point by applying predefined access rules to the specific device attributes of the issued signed digital device certificate to obtain a first access result; and
g3) if the first access result is positive, allowing the device to access the resource using the security rule enforcement point; else
if the first access result is negative, preventing the device from accessing the resource using the security rule enforcement point.

11. The method as claimed in claim 10, wherein the method also comprises, after checking according to step g2):
h) during security-critical access by way of the device (10) to the resource or during authentication of the device (10) in the access control apparatus, rechecking the permission to access the resource using the device and the security rule decision point by applying the predefined access rules to the specific device attributes of the issued signed digital device certificate to obtain a second access result;
i) during security-critical access by way of the device to the resource or during authentication of the device in the access control apparatus, resupplying the supplied specific device attributes; and/or
j) during the security-critical access by way of the device to the resource or during the authentication of the device in the access control apparatus, rechecking the permission to access the resource by way of the device by way of the security rule decision point by applying the predefined access rules to the resupplied specific device attributes of the issued signed digital device certificate to obtain a third access result.

12. The method as claimed in claim 10, wherein step g1) also comprises
supplying, on the basis of the request or further authentication of the device in the access control apparatus, the specific device attributes comprising second zero trust attributes having respective further ascertained values.

13. The method as claimed in claim 1, wherein the resource comprises a service including a provisioning server or an onboarding server.

14. (canceled)

15. A communication system for processing data, the system comprising:
a device to request a digital certificate using a certificate signature request;
a first supply unit to produce device attributes specific to the device in response to the signature request;
a second supply unit;
a performance unit;
a registration authority to perform a check on the certificate signature request and to encode the specific device attributes into the requested digital certificate to obtain a digital device certificate comprising the specific device attributes; and
a certificate authority to perform, if the check is successful, signing of the digital device certificate using the private key of the certificate authority to issue a signed digital device certificate;
wherein the second supply unit supplies the issued signed digital device certificate to the device; and
the performance unit performs an access scheme to access a resource by way of the device on the basis of the issued signed digital device certificate.
